(19) United States
(12) Patent Application Publication
(10) Pub. No.: US 2011/0264535 A1
(43) Pub. Date: Oct. 27, 2011

(54) AUCTION METHOD AND SYSTEM USING BIDS DEPENDING ON CLICKS OR VIEWS AND PERIOD, ADVERTISING METHOD AND SYSTEM, AND CHARGING METHOD AND SYSTEM

(75) Inventors: Choong Hee Lee, Seongnam-si (KR); Joongoo Lee, Seongnam-si (KR); Young Nahn Baek, Seongnam-si (KR); Ju Young Yang, Seongnam-si (KR); Jae Hyun Han, Seongnam-si (KR); Choong Hyun Nam, Seongnam-si (KR)

(73) Assignee: NHN BUSINESS PLATFORM CORP., Seongnam-si (KR)

(21) Appl. No.: 13/126,672

(22) PCT Filed: Mar. 23, 2009
(86) PCT No.: PCT/KR2009/001476

§ 371 Date: Jul. 14, 2011

(30) Foreign Application Priority Data
Nov. 4, 2008 (KR) 10-2008-0108837

(51) Int. Cl. G06Q 30/00

(52) U.S. Cl. 705/14.68; 705/14.69

(57) ABSTRACT

Disclosed are an auction method and system, an advertising method and system, and a charging method and system, based on bid prices depending on clicks or exposures, and a time period. The advertising method may include verifying an advertisement exposure priority determined with respect to an advertisement of an advertiser, based on a bid price per click (or a bid price per exposure), and a period-based bid price which may be input from the advertiser, and exposing the advertisement of the advertiser during a time period corresponding to the period-based bid price, through an advertisement exposure region depending on the verified advertisement exposure priority, wherein an advertising fee depending on the exposure of the advertisement may be calculated based on the bid price per click (or the bid price per exposure), a number of clicks (or a number of exposures) which may actually occur with respect to the advertisement during the time period, and the period-based bid price.

This application is the National Stage Entry of International Application PCT/KR2009/001476, filed on Mar. 23, 2009, and claims priority from and the benefit of Korean Patent Application No. 10-2008-0108837, filed on Nov. 4, 2008, both of which are incorporated herein by reference for all purposes as if fully set forth herein.

### BACKGROUND OF THE INVENTION

1. Field of the Invention

Exemplary embodiments of the present invention relate to an auction method and system, an advertising method and system, and a charging method and system, based on bid prices that depend on clicks or exposures, and a time period.

2. Discussion of the Background

Internet advertising enables enterprises to contact a great number of consumers at a low cost and immediately recognize reactions of customers to an advertisement using merits of the Internet. Among the Internet advertising methods, keyword advertising refers to an advertising method that displays an advertisement of a relevant enterprise on a screen as a search result, upon input of a search term. For example, when a user inputs a search term related to ‘moving’, advertisements related to ‘pack moving’, ‘moving center’, and the like may be exposed as a result of the search. Thus, since advertisements are displayed to those interested in particular goods or services, the advertising effect will be high.

### SUMMARY OF THE INVENTION

Exemplary embodiments of the present invention provide an auction method and system that may determine an advertisement exposure (display) priority, based on a bid price per click (or a bid price per exposure), and based on a period-based bid price, which may be input by advertisers, so as to be guaranteed a position where an advertisement may be displayed during a predetermined time period.

Exemplary embodiments of the present invention also provide an advertising method and system that may display an advertisement of a corresponding advertiser in an advertisement exposure region corresponding to the advertisement exposure priority determined based on the bid price per click (or the bid price per exposure), and the period-based bid price, among a plurality of advertisement exposure regions included in a web page.

Exemplary embodiments of the present invention also provide a charging method and system that may calculate an advertising fee based on the bid price per click (or the bid price per exposure), the period-based bid price, and a number of clicks (or a number of exposures) which may actually occur during a time period corresponding to the period-based bid price.

An exemplary embodiment of the present invention discloses an advertising method including determining an advertisement exposure priority of an advertisement of an advertiser, based on a bid price per click (or a bid price per exposure), and a period-based bid price which may be input from the advertiser, and displaying the advertisement during a time period corresponding to the period-based bid price, in an advertisement exposure region, depending on the verified advertisement exposure priority. An advertising fee depending on the exposure of the advertisement may be calculated based on the bid price per click (or the bid price per exposure), a number of clicks (or a number of exposures) which may actually occur with respect to the advertisement during the time period, and the period-based bid price.

An exemplary embodiment of the present invention also discloses an advertising system, including an advertisement exposure priority verification unit to determine an advertisement exposure priority an advertisement of an advertiser, based on a bid price per click (or a bid price per exposure), and a period-based bid price, which may be input from the advertiser, and an advertisement exposure unit to display the advertisement during a time period corresponding to the period-based bid price, in an advertisement exposure region, depending on the advertisement exposure priority. An advertising fee depending on the exposure of the advertisement may be calculated based on the bid price per click (or the bid price per exposure), a number of clicks (or a number of exposures) that actually occur with respect to the advertisement during the time period, and the period-based bid price.

An exemplary embodiment of the present invention also discloses an auction method, including receiving a bid price per click (or a bid price per exposure), and a period-based bid price, which may be input from at least one advertiser, and determining an advertisement exposure priority with respect to an advertisement of the advertiser, based on the bid price per click (or the bid price per exposure) and the period-based bid price. The advertisement may be displayed in an advertisement exposure region, depending on the advertisement exposure priority. An advertising fee of the advertisement may be calculated based on the bid price per click (or the bid price per exposure), the period-based bid price, and an actual number of clicks on (or a number of exposures) the advertisement that occur during a time period corresponding to the period-based bid price.

An exemplary embodiment of the present invention also discloses an auction system, including a bid price verification unit to receive a bid price per click (or a bid price per exposure) and a period-based bid price input from at least one advertiser, and an advertisement exposure priority determination unit to determine an advertisement exposure priority with respect to an advertisement, based on the bid price per click (or the bid price per exposure), and the period-based bid price. The advertisement may be displayed in an advertisement exposure region corresponding to the advertisement exposure priority, and an advertising fee may be calculated based on the bid price per click (or the bid price per exposure), the period-based bid price, and a number of clicks (or a number of exposures) that occur with respect to the advertisement, during a time period corresponding to the period-based bid price.

An exemplary embodiment of the present invention also discloses a charging method, including receiving a bid price per click (or a bid price per exposure), and a period-based bid price of an advertisement displayed in an advertisement exposure region, determining an actual number of clicks on or displays of the advertisement that occur during a time period corresponding to the period-based bid price, and calculating an advertising fee depending on the exposure of the advertisement, based on the bid price per click (or the bid price per exposure), the number of clicks (or the number of exposures), and the period-based bid price.

An exemplary embodiment of the present invention also discloses a charging system, including a bid price verification unit to receive a bid price per click (or a bid price per exposure), and a period-based bid price of an advertisement displayed in an advertisement exposure region, a number of clicks (number of exposures) verification unit to determine an actual number of clicks on or displays or to the advertisement that occur during a time period corresponding to the period-based bid price, and an advertising fee calculation unit to calculate an advertising fee of the advertisement, based on the bid price per click (or the bid price per exposure), the number of clicks (or the number of exposures), and the period-based bid price.

According to various embodiments of the present invention, advertising fee variations, which may occur according to variations in a number of clicks (or a number of displays) may be reduced, by determining an advertisement exposure priority through an auction, using a bid price per click (or a bid price per exposure) and a period-based bid price, and by calculating an advertising fee of an advertisement displayed in an advertisement exposure region corresponding to the advertisement exposure priority, based on both the bid price per click (or the bid price per exposure), and the period-based bid price.

According to embodiments of the present invention, various charging policies which may satisfy a request of an advertiser, by adjusting a ratio between a period-based flat rate fee determined based on the period-based bid price, and a weight for each fee determined by the advertiser, and a specific fee per click (or a specific fee per exposure) determined based on the bid price per click (or the bid price per exposure) and based on the number of clicks (or the number of exposures).

### BRIEF DESCRIPTION OF THE DRAWINGS

FIG. 1 is a diagram illustrating a general configuration of an auction system, an advertising system, and a charging system, according to an exemplary embodiment of the present invention.

FIG. 2 is a flowchart illustrating an auction method, according to an exemplary embodiment of the present invention.

FIG. 3 is a diagram illustrating a configuration of an auction system, according to an exemplary embodiment of the present invention.

FIG. 4 is a flowchart illustrating an advertising method, according to an exemplary embodiment of the present invention.

FIG. 5 is a diagram illustrating a configuration of an advertising system, according to an exemplary embodiment of the present invention.

FIG. 6 is a flowchart illustrating a charging method, according to an exemplary embodiment of the present invention.

FIG. 7 is a diagram illustrating a configuration of a charging system, according to an exemplary embodiment of the present invention.

FIG. 8 is an example of a table including information regarding a relationship among a bid price per click, a period-based bid price, a number of clicks, and an advertising fee.

### DETAILED DESCRIPTION OF THE ILLUSTRATED EMBODIMENTS

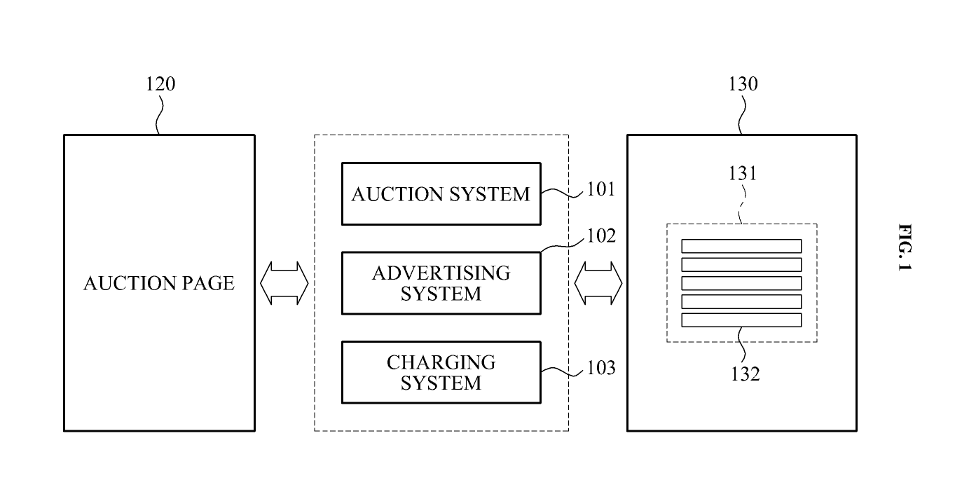

FIG. 1 is a diagram illustrating a general configuration of an auction system 101, an advertising system 102, and a charging system 103, according to an exemplary embodiment of the present invention. Each of the auction system 101, the advertising system 102, and the charging system 103 may be separate systems, or two or more of the systems may be combined. For example, the auction system 101, the advertising system 102, and the charging system 103 may be included in a single system, or only the auction system 101 may be separated, and operated in conjunction with a system including the advertising system 102, and the charging system 103.

The auction system 101 may receive, from an advertiser, a bid price per click, and a period-based bid price, through an advertiser page. An auction page 120 that may be used for conducting an auction with respect to an advertisement may also determine an advertisement exposure (display) priority, based on both the bid price per click, and the period-based bid price.

The advertising system 102 may display an advertisement through an advertisement exposure region according to the advertisement exposure priority, determined through the auction system 101. For example, the advertising system 102 may display an advertisement having a fifth advertisement exposure priority in a fifth advertisement exposure region 132, among a plurality of advertisement exposure regions included in an advertising region 131 of a web page 130. In this instance, the advertising system 102 may display the advertisement by displaying a link to a document corresponding to the advertisement in the fifth advertisement exposure region 132, and by providing a user with the document, when the user clicks the link while browsing the web page 130.

The charging system 103 may calculate an advertising fee depending on the exposure of the advertisement. In this instance, the charging system 103 may calculate the advertising fee based on the bid price per click and the period-based bid price, thereby reducing uncertainty which may occur due to a variation in a number of clicks, and also calculating the advertising fee depending on an advertising effect.

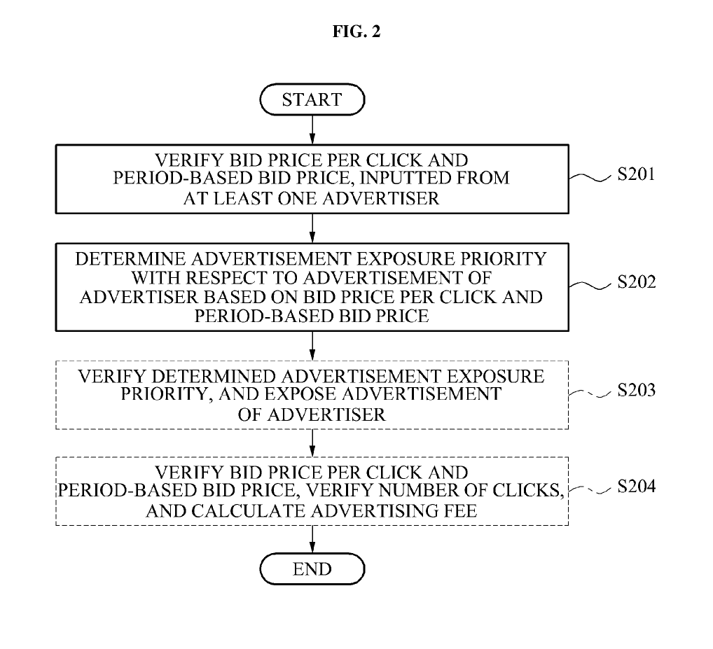

FIG. 2 is a flowchart illustrating an auction method according to an embodiment of the present invention. The auction method may be performed through the auction system 101, which has been described with reference to FIG. 1. In FIG. 2, the auction method will be described by describing a process of performing each operation by the auction system 101.

In operation S201, the auction system 101 may verify a bid price per click and a period-based bid price, which may be input from at least one advertiser. Here, the bid price per click and the period-based bid price may correspond to a bid price input by the advertiser so as to be guaranteed a position where an advertisement may be displayed during a predetermined time period, in an auction with respect to the position where the advertisement may be exposed. Whether the advertiser may successfully bid for the position may be determined based on both the bid price per click and the period-based bid price.

In operation S202, the auction system 101 may determine an advertisement exposure priority of the advertiser's advertisement, based on the bid price per click and the period-based bid price. The advertisement exposure priority may correspond to an advertisement exposure region. A plurality of advertisement exposure regions may be included on a single web page. The advertisement may be displayed at an advertisement exposure region during a time period corresponding to the period-based bid price. In this instance, the auction system 101 may determine the advertisement exposure priority corresponding to a position the advertisement is displayed in the exposure region of the web page. For example, a higher exposure priority may relate to a higher position in the exposure region, which may generate a higher advertising fee, with respect to an equal time period and an equal number of clicks.

For example, the auction system 101 may calculate a final bid price by adding up a fee per click calculated by applying an equal number of clicks to the verified bid price per click, and a period-based flat rate fee verified during an equal time period with respect to the verified period-based bid price. Then, the auction system may apply the highest advertisement exposure priority to an advertisement of an advertiser who submits the highest final bid price. The advertisement having the highest advertisement exposure priority may be displayed in the uppermost position of the advertisement exposure region of the web page. Any suitable form of auction may be used for determining the bid price the successful bid.

When the advertisement exposure priority of the advertisement is determined, the advertisement may be displayed in the advertisement exposure region corresponding to the advertisement exposure priority. An advertising fee depending on the exposure of the advertisement may be calculated based on the bid price per click and the period-based bid price, and based on a number of clicks on the advertisement during a time period corresponding to the period-based bid price. That is, the advertising fee may be calculated based on both the bid price per click and the period-based bid price, thereby reducing uncertainty that may occur according to variation in click numbers.

The advertising fee may be calculated based on: a specific fee per click based on the bid price per click and the number of clicks; a period-based flat rate fee based on the period-based bid price; and a weight for each fee determined by the advertiser. Here, the weight for each fee may include at least one of a ratio used to reflect the specific fee per click in the advertising fee, and a ratio used to reflect the period-based flat rate fee in the advertising fee. That is, various charging policies, which may satisfy a request of an advertiser, may be implemented, by calculating the advertising fee based on a ratio between the period-based flat rate fee and the specific fee per click. For example, a calculation of an advertising fee satisfying requests of advertisers who desire to have different percentages of an advertising fee relate to a predetermined time period and a number of clicks. That is, an advertising effect, may be possible by determining, by an administrator system, a weight for each fee with respect to the period-based flat rate fee, and a weight for each fee with respect to the specific fee per click, according to the requests of the advertisers, and by adjusting portions of the fees corresponding to the period-based flat rate fee and the specific fee per click in the entire advertising fee. The administrator system may refer to a system including at least one of the auction system 101, the advertising system 102, and the charging system 103, or a system including at least two of the three systems.

The exposure of the advertisement and the calculation of the advertising fee may be performed by the advertising system 102 and the charging system 103, which have been described with reference to FIG. 1. That is, operations S203 and S204 displayed in dotted line boxes in FIG. 2 may be operations that may be performed after the advertisement exposure priority is determined, and may be performed by the advertising system 102 and the charging system 103, respectively.

In operation S203, the advertising system 102 may verify an advertisement exposure priority with respect to an advertisement of an advertiser, based on a bid price per click, and a period-based bid price input from the advertiser. The advertising system 102 may display the advertisement during a time period corresponding to the period-based bid price, in an advertisement exposure region, depending on the verified advertisement exposure priority.

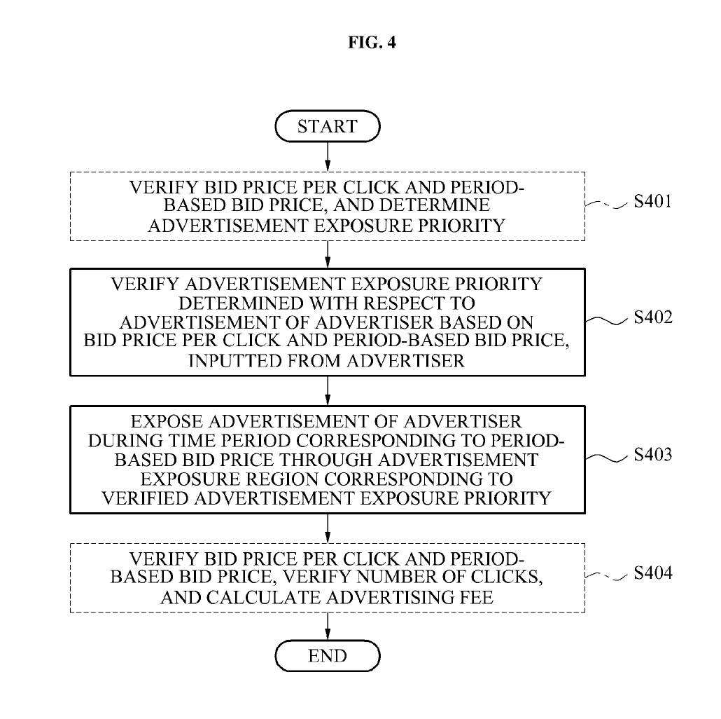

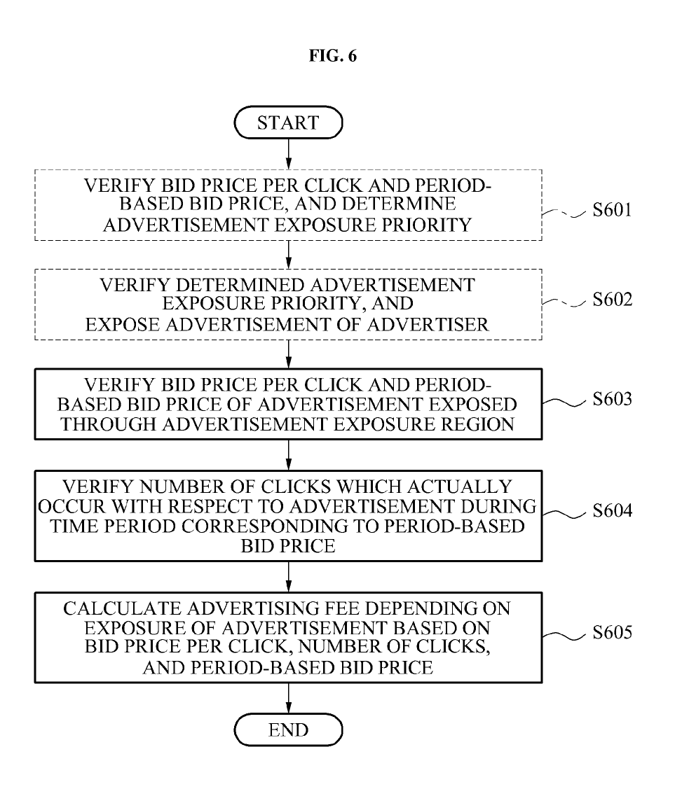

In operation S204, the charging system 103 may verify a bid price per click, and a period-based bid price of an advertisement displayed in an advertisement exposure region. The charging system 103 may verify a number of clicks that actually occur during a time period corresponding to the period-based bid price, and may calculate an advertising fee depending on the exposure of the advertisement, based on the bid price per click, the number of clicks, and the period-based bid price. An advertising method and a charging method similar to Operations S203 and S204 will be further described with reference to FIGS. 4 and 6.

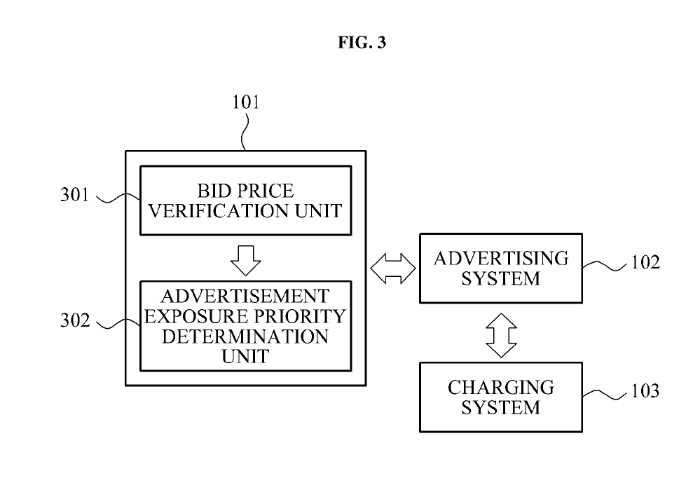

FIG. 3 is a diagram illustrating a configuration of the auction system 101, according to an exemplary embodiment of the present invention. The auction system 101 may include a bid price verification unit 301 and an advertisement exposure priority determination unit 302, as illustrated in FIG. 3.

The bid price verification unit 301 may verify a bid price per click, and a period-based bid price input from at least one advertiser. Here, the bid price per click and the period-based bid price may correspond to a bid price input by the advertiser during an auction, so as to be guaranteed a position where an advertisement may be displayed during a predetermined time period. Whether the advertiser's bid is successful may be based on both the bid price per click and the period-based bid price.

The advertisement exposure priority determination unit 302 may determine an advertisement exposure priority of an advertisement of the advertiser, based on the bid price per click, and the period-based bid price. The advertisement exposure priority may correspond to an advertisement exposure region. The advertisement may be displayed in the advertisement exposure region during a time period corresponding to the period-based bid price. The advertisement exposure priority determination unit 302 may assign the highest advertisement exposure priority to an advertisement of an advertiser who inputs a bid price per click and a period-based bid price that generates the highest advertising fee, with respect to a given time period and number of clicks.

For example, the advertisement exposure priority determination unit 302 may calculate a final bid price by adding a specific fee per click calculated by applying an equal number of clicks to the verified bid price per click to a period-based flat rate fee verified during an equal time period as the verified period-based bid price. Then, the advertisement exposure priority determination unit 302 may apply the highest advertisement exposure priority to the advertisement of an advertiser that inputs the highest final bid price. The advertisement having the highest advertisement exposure priority may be displayed at the uppermost position of the advertisement exposure region of the web page. Any suitable type of auction may be used to determine the final bid price.

Once the advertisement exposure priority is determined, the corresponding advertisement may be displayed in the advertisement exposure region corresponding to the advertisement exposure priority, and an advertising fee may be calculated based on the bid price per click and the period-based bid price, and based on an actual number of clicks on the advertisement, during a time period corresponding to the period-based bid price. That is, the advertising fee may be calculated based on both the bid price per click and the period-based bid price, thereby reducing uncertainty due to variations in the a number of clicks.

The advertising fee may be calculated based on: a specific fee per click determined based on the bid price per click and the number of clicks; a period-based flat rate fee determined based on the period-based bid price; and a weight for each fee determined by the advertiser. The advertising fee may be calculated based on a ratio between the period-based flat rate fee and the specific fee per click. For example, a calculation of an advertising fee satisfying requests of advertisers who may desire to increase a portion of a fee with respect to a time period, and advertisers who may desire to increase a portion of the fee depending on a number of clicks. That is, an advertising effect may be possible by determining, using an administrator system, a weight for the period-based flat rate fee, and a weight for the specific fee per click, according to the requests of the advertisers, and by adjusting portions of the fees corresponding to the period-based flat rate fee and the specific fee per click in the entire advertising fee. Here, the administrator system may refer to a system including at least one of the auction system 101, the advertising system 102, and the charging system 103, or a system including at least two of the three systems.

FIG. 4 is a flowchart illustrating an advertising method, according to an exemplary embodiment of the present invention. The advertising method may be performed through the advertising system 102, which has been described with reference to FIG. 1. In FIG. 4, the advertising method will be described by describing each operation by the advertising system 102.

Operation S401 may correspond to the auction method described with reference to FIG. 2, and may be performed through the auction system 101 described with reference to FIG. 1. In operation S401, the auction system 101 may verify a bid price per click and a period-based bid price, which may be input from at least one advertiser, and may determine an advertisement exposure priority with respect to the advertisement of the advertiser, based on the bid price per click and the period-based bid price. The determination process of the advertisement exposure priority has been described in detail with reference to FIG. 2, and accordingly, a further description will be omitted.

In operation S402, the advertising system 102 may verify an advertisement exposure priority of an advertisement, based on a bid price per click and a period-based bid price, which may be input by the advertiser. As aforementioned, the advertisement exposure priority may correspond to information regarding which advertisement exposure region an advertisement may be exposed through, among a plurality of advertisement exposure regions included on a single web page. When the input bid price per click and the period-based bid price are determined to be the highest input, the advertisement is assigned to the highest priority and is displayed at an uppermost position of the advertisement exposure region by the auction system 101, in operation S401. Then the advertising system 102 may verify the determined advertisement exposure priority.

In operation S403, the advertising system 102 may display the advertisement during a time period corresponding to the period-based bid price, in an advertisement exposure region, depending on the verified advertisement exposure priority. For example, the advertising system 102 may assign an advertisement to one of five exposure regions according to the priority thereof. When the advertisement exposure priority of an advertisement is the third priority, the advertisement may be displayed in the third advertisement exposure region, for example. The display of the advertisement may be performed by setting a link to a document corresponding to the advertisement, in a corresponding advertisement exposure region of the web page. The document may be provided to a user when the link is clicked on by the user.

Also, the advertising fee may be calculated based on the bid price per click, a number of actual clicks during the time period, and the period-based bid price. That is, the advertising fee may be calculated based on both the bid price per click and the period-based bid price, thereby reducing uncertainty which may occur due to a variation in the number of clicks, and also calculating the advertising fee depending on an advertising effect. For example, a number of clicks during the time period is predicted with respect to the advertisement exposure region, however, the number of clicks which may actually occur may be far different from the predicted number of clicks. Thus, the advertiser may need to pay an advertising fee much greater than expected. Accordingly, the advertising fee may be calculated based on the bid price per click, the number of clicks, and the period-based bid price, thereby reducing the pricing uncertainty.

The advertising fee may be calculated based on a specific fee per click determined based on the bid price per click and the number of clicks, a period-based flat rate fee determined based on the period-based bid price, and a weight for each fee determined by the advertiser. The weight for each fee may be set by an advertiser, as described above.

Operation S404 may correspond to the charging method depending on the exposure of the advertisement, and may be performed through the charging system 103, which has been described with reference to FIG. 1. In operation S404, the charging system 103 may verify a bid price per click, a period-based bid price of an advertisement exposed through an advertisement exposure region, and a number of actual clicks during a time period corresponding to the period-based bid price. The charging system 103 may calculate an advertising fee depending on the exposure of the advertisement, which is based on the bid price per click, the number of clicks, and the period-based bid price.

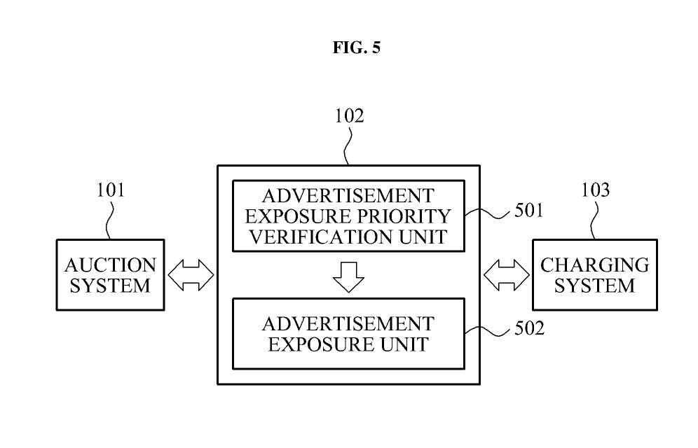

FIG. 5 is a diagram illustrating a configuration of the advertising system 102 according to an embodiment of the present invention. The advertising system 102 may include an advertisement exposure priority verification unit 501, and an advertisement exposure unit 502.

The advertisement exposure priority verification unit 501 may verify an advertisement exposure priority of an advertisement of an advertiser, based on a bid price per click, and a period-based bid price, which may be input from the advertiser. When the bid price per click and the period-based bid price are the highest input, the advertisement is assigned the highest priority and displayed in an uppermost position of the advertisement exposure region of the web page, by the auction system 101, in operation S401. then the advertising system 102 may verify the determined advertisement exposure priority.

The advertisement exposure unit 502 may display the advertisement of the advertiser during a time period corresponding to the period-based bid price, in an advertisement exposure region depending on the verified advertisement exposure priority. For example, the advertisement exposure unit 502 may display an advertisement in one of five different exposure regions, according to one of five assignable priorities. When the advertisement exposure priority of an advertisement is the third priority, the advertisement may be displayed in the third advertisement exposure region corresponding to the third priority. The display of the advertisement may be performed by displaying a link to a document corresponding to the advertisement in a corresponding advertisement exposure region of the web page.

Also, the advertising fee depending on the exposure of the advertisement may be calculated based on the bid price per click, a number of clicks which may actually occur during the time period, and the period-based bid price. That is, the advertising fee may be calculated based on the bid price per click and the period-based bid price, thereby reducing pricing uncertainty. Accordingly, the advertising fee may be calculated based on the bid price per click, the number of clicks, and the period-based bid price, thereby reducing the pricing uncertainty, which may occur according to the flexibility of the number of clicks.

The advertising fee may be calculated based on a specific fee per click determined based on the bid price per click and the number of clicks, a period-based flat rate fee determined based on the period-based bid price, and a weight for each fee determined by the advertiser. The weight for each fee may include a ratio between the specific fee per click in the advertising fee and the period-based flat rate fee. That is, various charging policies which may satisfy a request of an advertiser may be implemented by calculating the advertising fee based on a ratio between the period-based flat rate fee and the specific fee per click.

FIG. 6 is a flowchart illustrating a charging method, according to an exemplary embodiment of the present invention. The charging method may be performed through the charging system 103, which has been described with reference to FIG. 1. In FIG. 6, the charging method will be described by describing each operation by the charging system 103.

Operations S601 and S602 may be respectively performed by the auction system 101, and the advertising system 102. In operation S601, the auction system 101 may verify a bid price per click and a period-based bid price, which may be input from at least one advertiser, and may determine an advertisement exposure priority, based on the bid price per click and the period-based bid price. In operation S602, the advertising system 102 may verify an advertisement exposure priority, based on a bid price per click and a period-based bid price, which may be input by the advertiser. The advertising system 102 may display the advertisement during a time period corresponding to the period-based bid price, in an advertisement exposure region and depending on the verified advertisement exposure priority. The method of determining the advertisement exposure priority and exposing the advertisement has been described in detail with reference to FIGS. 2 through 4, and accordingly, a further description will be omitted.

In operation S603, the charging system 103 may verify a bid price per click, and a period-based bid price of an advertisement exposed through an advertisement exposure region. That is, the charging system 103 may verify the bid price per click and the period-based bid price of the advertisement, among the bid price per click and the period-based bid price which may be input from the advertiser in operation S601.

In operation S604, the charging system 103 may verify a number of clicks which may actually occur with respect to the advertisement, during a time period corresponding to the period-based bid price. That is, the charging system 103 may verify both the bid price per click and the number of actual clicks, and may calculate a specific fee per click depending on the actual number of clicks. For example, the charging system 103 may calculate the specific fee per click by multiplying the bid price per click and the number of the clicks.

In operation S605, the charging system 103 may calculate an advertising fee depending on the exposure of the advertisement, based on the bid price per click, the number of clicks, and the period-based bid price. The charging system 103 may calculate the advertising fee based on a specific fee per click determined based on the bid price per click and the number of clicks, a period-based flat rate fee determined based on the period-based bid price, and a weight for each fee determined. The advertising fee may be determined by an administrator system in accordance with a request of the advertiser.

The weight for each fee may include at least one of a ratio used to reflect the specific fee per click in the advertising fee, and a ratio used to reflect the period-based flat rate fee in the advertising fee. When the weight for each fee is used, portions of the fees corresponding to a period-based flat rate fee, where an advertising fee may be verified before displaying the advertisement, and the specific fee per click, where the advertising fee may be calculated based on benefits of the advertisement, may be adjusted to satisfy the request of the advertiser.

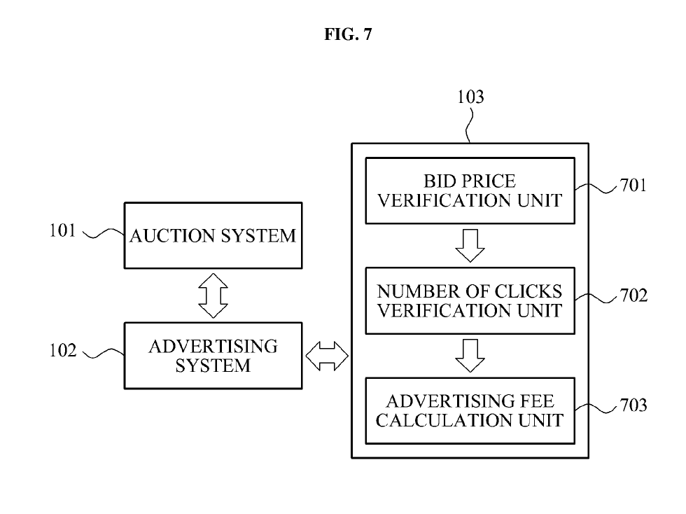

FIG. 7 is a diagram illustrating a configuration of the charging system 103 according to an exemplary embodiment of the present invention. The charging system 103 may include a bid price verification unit 701, a number of clicks verification unit 702, and an advertising fee calculation unit 703, as illustrated in FIG. 7.

The bid price verification unit 701 may verify a bid price per click, and a period-based bid price of an advertisement exposed through an advertisement exposure region. The bid price verification unit 701 may verify the bid price per click and the period-based bid price of the advertisement, among the bid prices per click and the period-based bid prices input by various advertisers. The advertisement may refer to an advertisement displayed in an advertisement exposure region corresponding to an advertisement exposure priority. The advertisement exposure priority may be determined based on the bid price per click and the period-based bid price.

The number of clicks verification unit 702 may verify an actual number of clicks on the advertisement during a time period corresponding to the period-based bid price. The number of clicks verification unit 702 may verify both the bid price per click and the actual number of clicks, and may calculate a specific fee per click depending on the number of clicks which may occur. For example, the number of clicks verification unit 702 may calculate the specific fee per click by multiplying the bid price per click and the number of the clicks.

The advertising fee calculation unit 703 may calculate an advertising fee based on the bid price per click, the number of clicks, and the period-based bid price. The advertising fee calculation unit 703 may calculate the advertising fee based on a specific fee per click determined based on the bid price per click and the number of clicks, a period-based flat rate fee determined based on the period-based bid price, and a weight for each fee determined by an administrator system, in accordance with a request of the advertiser. That is, click number uncertainty may be reduced. Also, an advertising fee depending on achievements of the advertisement may be calculated based on the bid price per click.

The weight for each fee may include at least one of a ratio used to reflect the specific fee per click and the period-based flat rate fee in the advertising fee. When the weight for each fee determined by the administrator system, in accordance with the request of the advertiser is used. Portions of the fees corresponding to a period-based flat rate fee and the specific fee per click may be adjusted to satisfy the request of the advertiser.

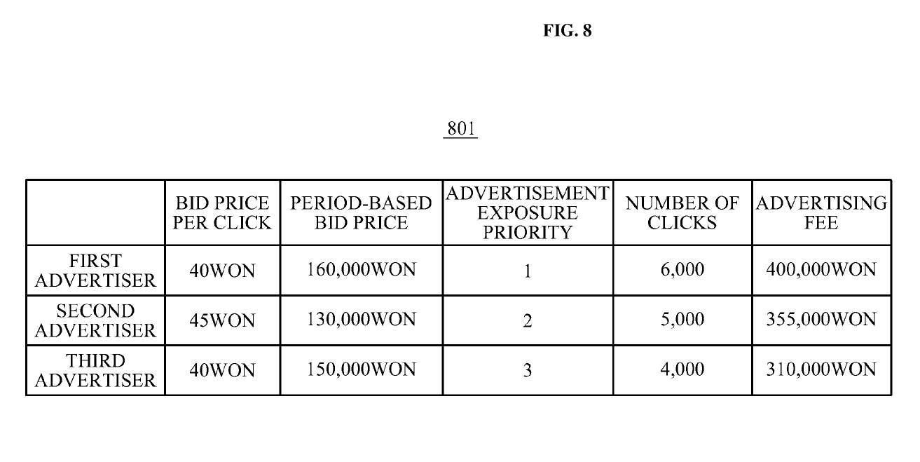

FIG. 8 is an example of a table 801 regarding a relationship among a bid price per click, a period-based bid price, a number of clicks, and an advertising fee. Each of a first advertiser through a third advertiser may input a bid price per click, and a period-based bid price. The auction system 101 may determine advertisement exposure priorities based on the bid prices per click and the period-based bid prices. The table 801 may represent an example in which a final bid price may be calculated by adding up a specific fee per click, calculated by applying an equal number of clicks to the verified bid price per clicks, and a period-based flat rate fee, verified during an equal time period with respect to the verified period-based bid price. An advertisement of an advertiser who inputs the highest final bid price may be assigned the highest advertisement exposure priority. Here, when it is assumed that the period-based bid prices input by the first advertiser through the third advertiser may be bid prices with respect to an equal time period, and the equal number of clicks may correspond to “5,000”, the final bid price of the first advertiser may be determined to be “360,000 won”, the final bid price of the second advertiser may be determined to be “355,000 won”, the final bid price of the third advertiser may be determined to be “350,000 won.” Accordingly, the advertisement exposure priority of the table 801 may be determined.

In this instance, advertisements of the advertisers may be exposed through corresponding advertisement exposure regions during a time period corresponding to the period-based bid price, using the advertising system 102. In this instance, the charging system 103 may determine advertising fees depending on the display of the advertisements based on the bid prices per click, the period-based bid prices, and the number of clicks. For example, the advertising fee of the first advertiser may be determined by multiplying the bid price per click and the number of clicks, and then by summing a result of the multiplication with the period-based bid price, that is, (“40 won”×“6,000”)+“160,000 won”=“400,000 won.”

Also, a weight for each fee corresponding to a predetermined ratio may be applied to the period-based flat rate fee of “160,000 won” determined based on the period-based bid price, or to a specific fee per click of “40 won×6,000” determined based on the bid price per click, and the number of clicks. For example, when a weight for each fee of “1.1” is applied to the specific fee per click, and a weight for each fee of “0.8” is applied to the period-based flat rate fee, for an advertiser who may desire to attach a higher importance to the specific fee per click, where an advertising fee may be determined based on an advertising effect, the advertising fee of the first advertiser may be calculated by (“40 won”×“6000”×“1.1”)+(“160,000”×“0.8”)=“392,000 won.” The weight for each fee may be predetermined by an administrator system, in accordance with a request of the advertiser, before displaying the advertisement.

When using the auction system, the advertising system, and the charging system, according to exemplary embodiments of the present invention, uncertainty of an advertising fee may be reduced, by determining an advertisement exposure priority through an auction using a bid price per click, and a period-based bid price, and by calculating an advertising fee depending on display of an exposure of an advertisement through an advertisement exposure region corresponding to the advertisement exposure priority, based on both the bid price per click, and the period-based bid price. Also, various charging policies which may satisfy a request of an advertiser may be implemented, by adjusting a ratio between a period-based flat rate fee determined based on the period-based bid price, and a specific fee per click determined based on the bid price per click and the number of clicks.

According to embodiments of the present invention, charging with respect to display of an advertisement may also be possible, in addition to charging with respect to clicks of an advertisement. The charging depending on the display may be performed through an equivalent configuration, using a bid price per display instead of the bid price per click, a number of displays instead of the number of clicks, and a specific fee per display instead of the specific fee per click. As such, a duplicated description will be omitted. In this case, uncertainty of an advertising fee according to flexibility of a number of exposures may be reduced.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. An advertising method comprising:
assigning an advertisement exposure priority to an advertisement of an advertiser, based on a bid price per click or display and a period-based bid price, which are received from the advertiser; and
displaying the advertisement during a time period corresponding to the period-based bid price, in an advertisement exposure region of a web page, the advertisement exposure region corresponding to the assigned advertisement exposure priority,
wherein an advertising fee of the advertisement is calculated based on the bid price per click or display, a number of times the advertisement is clicked on or displayed during the time period, and the period-based bid price.

2. The method of claim 1, wherein:
the web page comprises a plurality of the advertisement exposure regions that correspond to different advertisement exposure priorities; and
when the bid price per click or display and the period-based bid price produce the highest advertising fee, the advertisement is displayed in an uppermost position of the advertisement exposure region.

3. The method of claim 1, wherein the advertising fee is calculated based on a specific fee per click or display that is determined based on the bid price per click or display, the number of clicks or displays, a period-based flat rate fee based on the period-based bid price, and a weight for each of the fees input by the advertiser.

4. The method of claim 3, wherein the weight for each fee comprises a ratio between the specific fee per click or display and the period-based flat rate fee.

5. An auction method, comprising:
receiving a bid price per click or display and a period-based bid price from at least one advertiser; and
assigning an advertisement exposure priority to an advertisement of the advertiser, based on the bid price per click or display and the period-based bid price,
wherein the advertisement exposure priority determines the relative location the advertisement is displayed in an advertisement exposure region of a web page, and
an advertising fee of the advertisement-is calculated based on the bid price per click or display, the period-based bid price, and an actual number of clicks on or displays of the advertisement during a time period corresponding to the period-based bid price.

6. The method of claim 5, wherein:
the advertisement is displayed in the advertisement exposure region during the time period corresponding to the period-based bid price; and
the assigning comprises assigning a highest exposure priority to the advertisement, such that the advertisement is displayed in an uppermost position of the advertisement exposure region of the web page, when the bid price per click or display and the period-based bid price generate the highest advertising fee for a given time period and number of clicks or displays.

7. The method of claim 5, wherein the advertising fee is calculated based on a specific fee per click or display based on the bid price per click or display, the actual number of clicks or displays, a period-based flat rate fee based on the period-based bid price, and a weight for each fee determined by the advertiser.

8. The method of claim 7, wherein the weight for each fee comprises a ratio between the specific fee per click or display and the period-based flat rate fee.

9. A charging method, comprising:
receiving a bid price per click or display and a period-based bid price of an advertisement displayed in an advertisement exposure region;
determining an actual number of clicks or displays of the advertisement during a time period corresponding to the period-based bid price; and
calculating an advertising fee of the advertisement, based on the bid price per click or display, the number of clicks or displays, and the period-based bid price.

10. The method of claim 9, wherein:
the advertisement is displayed in an advertisement exposure region corresponding to an advertisement exposure priority that is based on the bid price per click or display and the period-based bid price; and
the advertisement exposure priority is determined such that an advertisement corresponding to a bid price per click or display and a period-based bid price that generate the highest advertising fee are assigned the highest exposure priority, the highest exposure priority corresponding to an advertisement exposure region of the web page that is most likely to be viewed.

11. The method of claim 9, wherein the calculating comprises calculating the advertising fee based on a specific fee per click or display that is based on the bid price per click or display and the number of clicks or displays, a period-based flat rate fee determined based on the period-based bid price, and a weight for each fee input by the advertiser.

12. The method of claim 11, wherein the weight for each fee comprises a ratio of the specific fee per click or display and the period-based flat rate fee.

13. A non-transitory computer-readable medium comprising a program for instructing a computer to perform the method claim 1.

14. An advertising system, comprising:
an advertisement exposure priority verification unit to determine an advertisement exposure priority of an advertisement of an advertiser, based on a bid price per click or display and a period-based bid price, which are input by the advertiser; and
an advertisement exposure unit to display the advertisement during a time period corresponding to the period-based bid price, in an advertisement exposure region of a web page, the exposure region corresponding to the advertisement exposure priority,
wherein an advertising fee of the advertisement is calculated based on the bid price per click or display, an actual number of clicks on or displays of the advertisement during the time period, and the period-based bid price.

15. The system of claim 14, wherein:
the advertisement exposure priority corresponds to an advertisement exposure region an advertisement is displayed in, among a plurality of advertisement exposure regions of a web page; and
when the bid price per click or display and the period-based bid price produce the highest advertising fee, the advertisement is displayed in an uppermost position of the advertisement exposure.

16. The system of claim 14, wherein the advertising fee is calculated based on a specific fee per click or display determined based on the bid price per click or display and the number of clicks or displays, a period-based flat rate fee based on the period-based bid price, and a weight for each fee input by the advertiser.

17. An auction system, comprising:
a bid price verification unit to receive a bid price per click or display and a period-based bid price input from at least one advertiser; and
an advertisement exposure priority determination unit to determine an advertisement exposure priority of an advertisement of the advertiser, based on the bid price per click or display and the period-based bid price,
wherein the advertisement exposure priority corresponds to an advertisement exposure region in which the advertisement will be displayed, and
an advertising fee of the advertisement is calculated based on the bid price per click or display, the period-based bid price, and an actual number of clicks on or displays of the advertisement during a time period corresponding to the period-based bid price.

18. The system of claim 17, wherein
the advertisement is displayed in the advertisement exposure region during the time period corresponding to the period-based bid price, and
the advertisement exposure priority determination unit determines the advertisement exposure priority, such that an advertisement corresponding to a bid price per click or display and a period-based bid price that generate the highest advertising fee are assigned the highest exposure priority, the highest exposure priority corresponding to an to advertisement exposure region of the web page that is most likely to be viewed.

19. The system of claim 17, wherein the advertising fee is calculated based on a specific fee per click or display that is based on the bid price per click or display and the number of clicks or displays, a period-based flat rate fee determined based on the period-based bid price, and a weight for each fee input by the advertiser.

20. A charging system, comprising:
a bid price verification unit to receive a bid price per click or display and a period-based bid price of an advertisement displayed in an advertisement exposure region of a web page;
a number of clicks or displays verification unit to determine an actual number of clicks on or displays of the advertisement that occur during a time period corresponding to the period-based bid price; and
an advertising fee calculation unit to calculate an advertising fee of the advertisement, based on the bid price per click or display, the number of clicks or displays, and the period-based bid price.

21. The system of claim 20, wherein
the advertisement is displayed in an advertisement exposure region corresponding to an advertisement exposure priority that is based on the bid price per click or display and the period-based bid price; and
the advertisement exposure priority is determined such that an advertisement corresponding to a bid price per click or display and a period-based bid price that generate the highest advertising fee are assigned the highest exposure priority, the highest exposure priority corresponding to an advertisement exposure region of the web page that is most likely to be viewed.

22. The system of claim 20, wherein the calculating comprises calculating the advertising fee based on a specific fee per click or display that is based on the bid price per click or display and the number of clicks or displays, a period-based flat rate fee determined based on the period-based bid price, and a weight for each fee input by the advertiser.
